(19) United States
(12) Patent Application Publication
(10) Pub. No.: US 2010/0051137 A1
(43) Pub. Date: Mar. 4, 2010

(54) PORTABLE WORKBENCH

(76) Inventor: Jon Layton, Saratoga Springs, UT (US)

Correspondence Address: ADVANTIA LAW GROUP, 9035 SOUTH 1300 EAST, SUITE 200, SANDY, UT, 84094, US

(21) Appl. No.: 12/201,629

(22) Filed: Aug. 29, 2008

(51) Int. Cl. B25H 1/00

(52) U.S. Cl. 144/286.5; 144/287

(57) ABSTRACT

A workbench assembly is provided including: a sawhorse, a mounting bracket, a planar member, and a power outlet. The sawhorse includes: a track, and a pair of support legs extending downwardly from the track. The mounting bracket is configured to releaseably couple to the track of the sawhorse. The planar member, having a primary plane, is coupled to the mounting bracket and configured to provide a tabletop when the mounting bracket is coupled to the track such that the primary plane tapers at a tapered end. The power outlet is coupled to the planar member.

### BACKGROUND OF THE INVENTION

1. Field of the Invention

The present invention relates to workbenches, specifically to portable workbenches.

2. Description of the Related Art

It is estimated that construction amounts to 4.9 percent of the GNP of the United States. Of that, only a tiny fraction takes place in shops and facilities, the majority of it taking place on-site. Accordingly, there is a huge need for tools and equipment to facilitate such projects.

Workbenches are commonly used for facilitating projects, especially construction projects. In particular, it is generally more useful to bring tools to a project than vice versa. Accordingly, construction workers often have the need for portable workbenches for easy transport to and from construction sites. Traditionally, construction workers have used wooden sawhorses as a base for providing a workbench. Wooden sawhorses, however, are a minimalist approach to the problem and provide only the bare need of a workspace.

Accordingly, several other portable workbenches have developed to fill this need as well. Examples are described below, and the supported teachings of each reference are incorporated by reference herein:

U.S. Pat. No. 6,745,804 to Welsh, et al., discloses a portable work bench which includes a beam, legs for supporting the beam, and at least one bracket having first and second surfaces for contacting respective first and second sides of the beam, wherein the second surface is movable between a first position contacting the second side of the beam, and a second position not contacting the second side of the beam. A spring biases the second surface towards the first position.

U.S. Pat. No. 5,320,150 to Everts, et al., discloses a collapsible stand having a top formed by two mating leaves and supported by legs. The legs are pivotedly joined to braces underlying the leaves. The components of the stand pivot with respect to one another so to allow the stand to be easily erected and collapsed. However, due to interaction between at least one of the braces and at least one retainer on the underside of one of the leaves the stand cannot be collapsed without initial planar movement of the leaves away from one another. Since such movement is rare during normal usage, the stand is strong and secure during normal usage. A pair of brackets for holding dimensional lumber may be attached to the braces. When the lumber is placed in the brackets, the stand is further secured in its erect position.

U.S. Pat. No. 5,875,828 to Quiram, et al., discloses a portable work bench which includes a structural body, and a platform disposed on and frictionally contacting the structural body. In addition, the platform includes an override mechanism for allowing horizontal movement of the platform along the structural body. Further, the portable work bench may include a plurality of legs for supporting the structural body. The structural body may be tubular and preferably has a trapezoidal cross-section. Such work bench can be used by disposing the platform on the structural body, so that the platform frictionally contacts the structural body. Then the user can mechanically override the static friction between the platform and the structural body and move the platform horizontally along the structural body.

U.S. Design Pat. No. D304,650 to Price, discloses an ornamental design for a foldable power tool support, as shown and described.

The inventions heretofore known suffer from a number of disadvantages which include being difficult to collapse for transport, taking up a large amount of space when collapsed, being less stable than other work benches, providing a narrow surface, being difficult to provide power to power tools, and being difficult to readily access tools.

What is needed is a portable workbench that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available workbenches. Accordingly, the present invention has been developed to provide an improved portable workbench.

In a first implementation, a workbench assembly is provided including: a sawhorse, a mounting bracket, a planar member, and a power outlet. The sawhorse includes: a track, and a pair of support legs extending downwardly from the track. The mounting bracket is configured to releaseably couple to the track of the sawhorse. The planar member, having a primary plane, is coupled to the mounting bracket and configured to provide a tabletop when the mounting bracket is coupled to the track, such that the primary plane tapers at a tapered end. The power outlet is coupled to the planar member.

One or more of the following features may be included in an embodiment of the invention. The workbench assembly may further include a telescoping extension track configured to telescope into and out of the track, such that the telescoping extension track provides an additional length of longitudinal support when extended. The workbench assembly may further include a carriage selectably coupleable to the telescoping extension track to place objects thereon. The mounting bracket may include a first flange configured to wrap around a first lip of the track, a second flange configured to releaseably wrap around a second lip of the track and a mounting bracket body that couples the first flange and the second flange into a unit. The pair of supporting legs may swivel inwardly toward the track thereby providing a mechanism to collapse the pair of supporting legs for easier transport and storage. The pair of supporting legs may be detachable thereby providing easier transport and storage. The sawhorse may further include a handle coupled to the track.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features, or advantages, of a particular embodiment. In other instances, additional features, and advantages, may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a perspective view of a workbench assembly, according to one embodiment of the invention;

FIG. 2 is an exploded view of a workbench assembly, according to one embodiment of the invention;

FIG. 3 is a side view of a mounting bracket, according to one embodiment of the invention; and

FIG. 4 is a top view of a workbench assembly, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will, nevertheless, be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar or the same, etc.

Each statement of an “embodiment”, or “example”, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole, or in part, one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

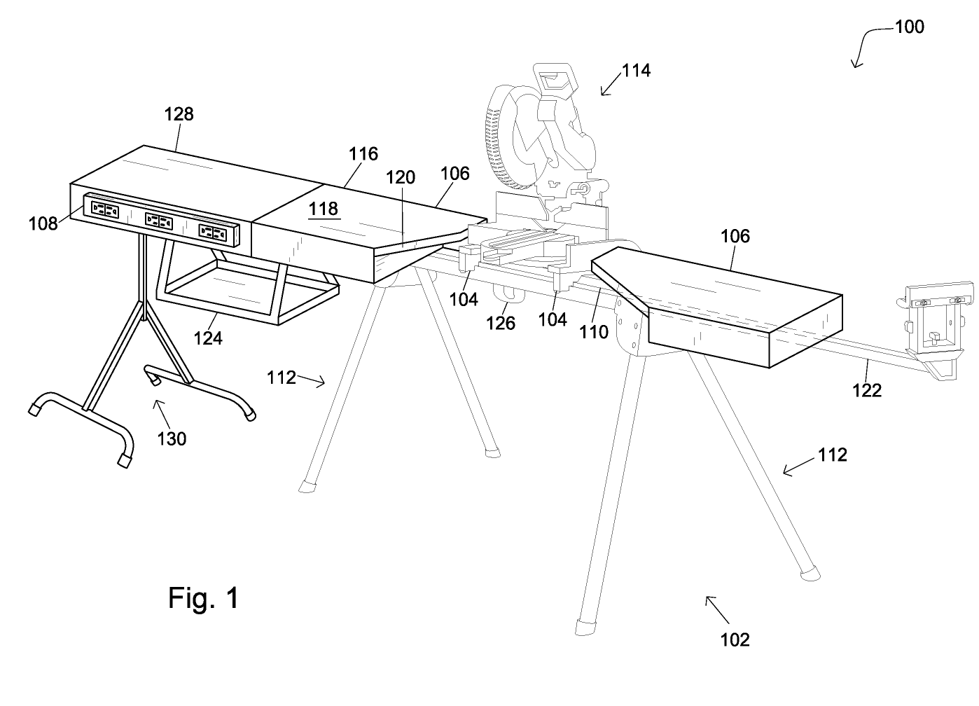

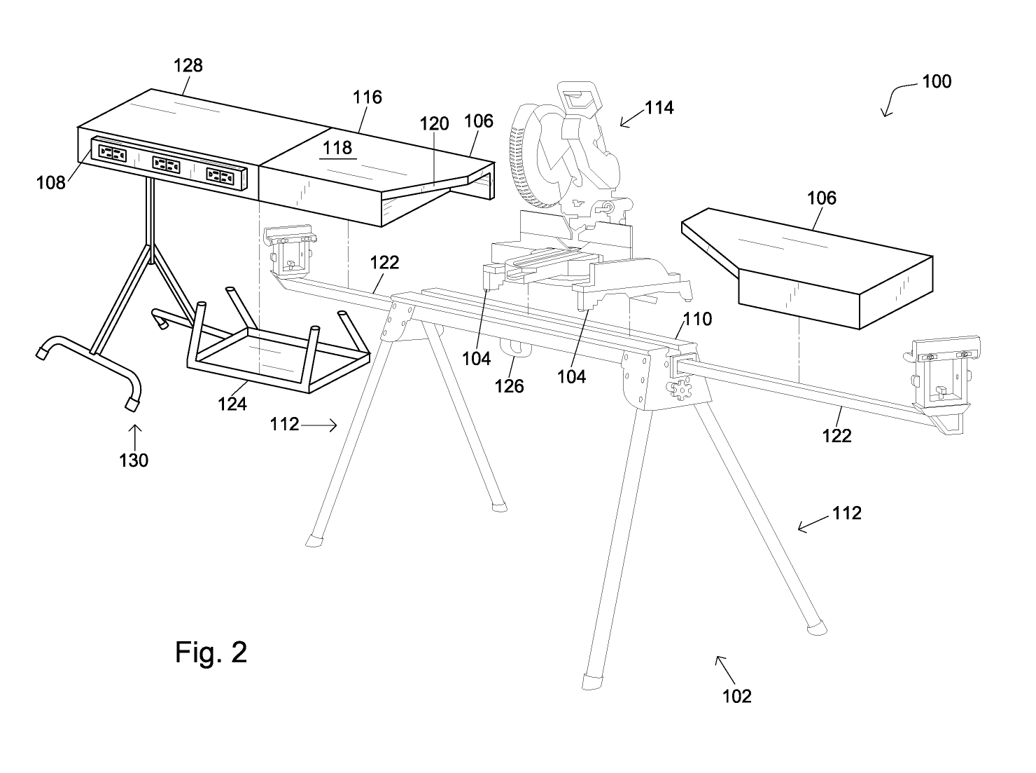

FIGS. 1 and 2 are views of a workbench assembly according to one embodiment of the invention. A workbench assembly 100 is shown including: a sawhorse 102, a mounting bracket 104 removably coupleable to the sawhorse, a planar member 106 coupled to another mounting bracket and configured to provide a working surface when that mounting bracket is coupled to the sawhorse, a power outlet 108 coupled to a side of the planar member and configured to provide power whereby a user may attach power tools such as drills, saws, and the like, and a carriage 124. The illustrated workbench assembly provides a surface on which a user may work that is far enhanced over a simple sawhorse.

Sawhorses are known in the art and have traditionally been constructed with wood. The sawhorse 102, however, may be made of any suitable material, including but not limited to: wood, metal, or plastic. The sawhorse 102 includes: a track 110, and a pair of support legs 112 extending downwardly from the track. Traditionally, support legs on a sawhorse are angled downwardly and outwardly thereby forming a triangular shape. It is envisioned that the sawhorse may have any type of support legs that extend downwardly and provide sufficient support for the workbench assembly 100. The track 110 may be constructed of any suitable material and is configured such that devices may be releaseably coupled thereto.

The illustrated mounting bracket 104 is configured to releaseably couple to the track 110 of the sawhorse 102. The mounting bracket 104 is coupled to a miter saw 114. The coupling may be performed in a number of ways including, but not limited to, bolt and nut, screws, and welding. Similarly, the planar member 106, having a primary plane 116, may be coupled to the mounting bracket 104 and configured to provide a tabletop 118 when the mounting bracket 104 is coupled to the track 110. The tabletop 118 may then be used, for example, to place tools and/or pieces of material thereon. Further, the primary plane 116 tapers at a tapered end 120. This may allow a worker easier access to the miter saw 114, and allow beveling of the miter saw's base.

Primary plane 116 may be divided into two sections as shown. A platform stand 128 is connected to a platform leg 130. The platform leg 130 may be any configuration which supports the platform stand 128 and elevates the platform stand 128 to an appropriate height. The platform leg 130 may also swivel into the platform stand 128. This allows the platform stand 128 and the platform leg 130 to collapse together for compact transportation.

The power outlet 108 is coupled to the planar member. This provides an easy way for a worker to plug in power tools without having to run an extension cord to the tools directly. The power outlet 108 is shown on the side of the planar member 106, but it is envisioned that the power outlet 108 could be mounted on any side; the top, the bottom, or any other surface that may comprise the planar member 106.

The workbench assembly 100 may further include a telescoping extension track 122 configured to telescope into and out of the track 110, such that the telescoping extension track 122 provides an additional length of longitudinal support when extended. This allows for more compact transport and storage of the workbench assembly 100 when it is collapsed. It further provides a way to minimize and/or selectably size the profile of the workbench assembly 100 when working in an area with limited space.

The workbench assembly 100 may further include a carriage 124 selectably coupleable to the telescoping extension track 122 to place objects thereon. This provides easy storage for tools and ready access to tools when they are needed. The carriage 124 may be constructed with any suitable material and coupled by any means know in the art. The carriage 124 may be easily removable for transport.

The pair of supporting legs 112 may swivel inwardly, toward the track 110, thereby providing a mechanism to collapse the pair of supporting legs for easier transport and storage, and/or the pair of supporting legs 112 may be detachable and thereby provide easier transport and storage.

The sawhorse 102 may further include a handle 126 coupled to the track, as shown in the figures. The handle may be used to transport the workbench assembly 100 once it is collapsed.

In operation, a user may bring the collapsed workbench assembly 100 to a worksite. By swiveling the pair of supporting legs 112 downwardly and outwardly from the track 110, the sawhorse 102 is expanded to stand upright. Next the user may slide the telescoping extension track 122 out and attach the carriage 124 thereto. Using mounting brackets 104, the user may then couple the planar member 106 to the track 110. thereby creating a tabletop 118 to work on. The user may also attach a miter saw 114 to the track 110 using mounting brackets 104. The user may then plug in the miter saw 114 and other tools into power outlet 108.

When the user is finished using the workbench assembly 100 at the worksite, the user may then collapse the workbench assembly 100 by decoupling the planar member 106 from the track 110 by releasing the mounting brackets 104 from the track 110. Similarly the miter saw 114 may be decoupled from the track 110 by releasing the mounting brackets 104 from the track 110. Next the user may detach the carriage 124 from the telescoping extension track 122, and then may slide the telescoping extension track 122 back into the track 110. To complete the collapsing process, the user may then swivel the pair of supporting legs 112 upwardly and inwardly.

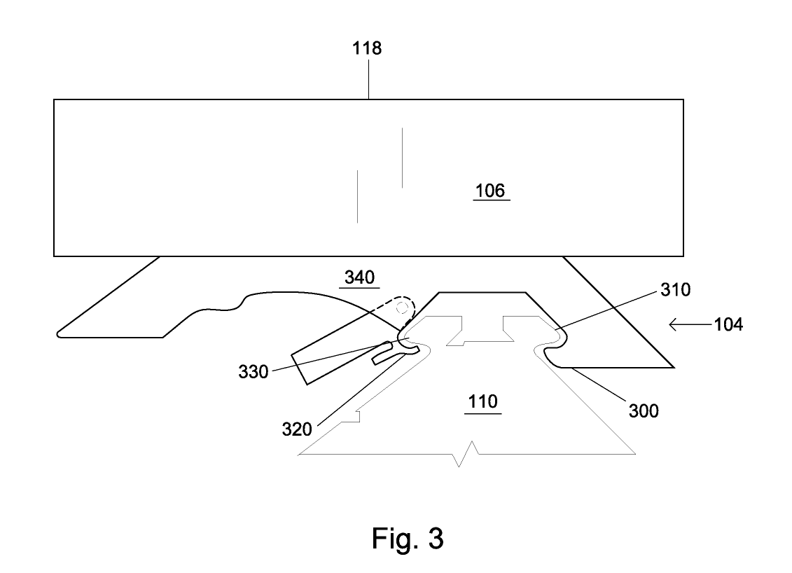

FIG. 3 is a side view of a mounting bracket 104, according to one embodiment of the invention. The mounting bracket 104 includes a first flange 300 configured to wrap around a first lip 310 of the track 110, a second flange 320 configured to releaseably wrap around a second lip 330 of the track 110, and a mounting bracket body 340 that couples the first flange 300 and the second flange 320 into a unit. Accordingly, the mounting bracket may be coupled to another member and serve to selectably couple such to a track.

In operation, the mounting bracket 104 is coupled to the track when desired. To attach the mounting bracket 104 to the track, the second flange 320 is pivoted outward while the first flange 300 is wrapped around the first lip 310, and then the second flange is wrapped around the second lip 330 by pivoting the second flange 320 into a wrapping position around the second lip 330. Similarly, to release the mounting bracket 104, the second flange 320 is pivoted away from the second lip 330. The mounting bracket 104 may in turn be coupled to other objects such as a miter saw 114 or planar member 106 thereby coupling the other objects to the track.

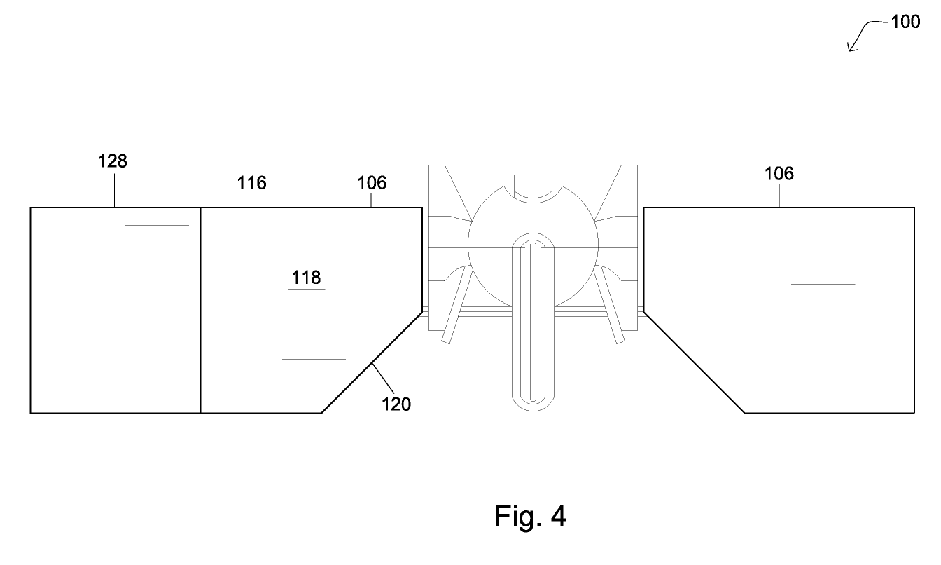

FIG. 4 is a top view of a workbench assembly 100, according to one embodiment of the invention. A workbench assembly 100 is shown including planar member 106 having a primary plane 116 and creating a tabletop 118 as shown. The primary plane 116 tapers at a tapered end 120. Primary plane 116 may be divided into two sections.

In operation, the tabletop 118 may be used to place tools, work pieces, or other objects thereon. Tapered end 120 allows for easy access to tabletop 118. As previously described, the planar member may be removed and attached to track 110 for easy transport.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the figures illustrate a carriage 124 with straps extending upwardly on the side, the carriage 124 may have solid walls extending upwardly and configured to attach to the track 110. Additionally, the carriage 124 may have straps extending from areas other than the sides including the center.

It is also envisioned that the pair of support legs 112 are rubber tipped, such that the device does not slide on a slippery surface.

It is expected that there could be numerous variations of the design of this invention. Finally, it is envisioned that the components of the device may be constructed of a variety of materials.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A workbench assembly, comprising:
a) a sawhorse having:
i. a track, and
ii. a pair of support legs extending downwardly from the track;
b) a mounting bracket configured to releaseably couple to the track of the sawhorse;
c) a planar member having a primary plane, being coupled to the mounting bracket and configured to provide a tabletop when the mounting bracket is coupled to the track, wherein the primary plane tapers at a tapered end; and
d) a power outlet coupled to the planar member.

2. The workbench assembly of claim 1, further comprising:
a) a telescoping extension track configured to telescope into and out of the track, whereby the telescoping extension track provides an additional length of longitudinal support when extended.

3. The workbench assembly of claim 2, further comprising:
a) a carriage selectably coupleable to the telescoping extension track to place objects thereon.

4. The workbench assembly of claim 1, wherein the mounting bracket comprises:
a) a first flange configured to wrap around a first lip of the track;
b) a second flange configured to releaseably wrap around a second lip of the track; and
c) a mounting bracket body that couples the first flange and the second flange into a unit.

5. The workbench assembly of claim 1, wherein the pair of supporting legs swivel inwardly toward the track thereby providing a mechanism to collapse the pair of supporting legs for easier transport and storage.

6. The workbench assembly of claim 1, wherein the pair of supporting legs is detachable and thereby provides easier transport and storage.

7. The workbench assembly of claim 1, wherein the sawhorse further comprises:
a) a handle coupled to the track.

8. A workbench assembly, comprising:
a) a sawhorse having:
i. a track, and
ii. a pair of support legs extending downwardly from the track;
b) a mounting bracket configured to releaseably couple to the track of the sawhorse;
c) a planar member having a primary plane, being coupled to the mounting bracket and configured to provide a tabletop when the mounting bracket is coupled to the track; and
d) a power outlet coupled to the planar member.

9. The workbench assembly of claim 8, further comprising:
a) a telescoping extension track configured to telescope into and out of the track, whereby the telescoping extension track provides an additional length of longitudinal support when extended.

10. The workbench assembly of claim 9, further comprising:
a) a carriage selectably coupleable to the telescoping extension track to place objects thereon.

11. The workbench assembly of claim 8, wherein the mounting bracket comprises:
a) a first flange configured to wrap around a first lip of the track;
b) a second flange configured to releaseably wrap around a second lip of the track; and
c) a mounting bracket body that couples the first flange and the second flange into a unit.

12. The workbench assembly of claim 8, wherein the pair of supporting legs swivel inwardly toward the track thereby providing a mechanism to collapse the pair of supporting legs for easier transport and storage.

13. The workbench assembly of claim 8, wherein the pair of supporting legs is detachable and thereby provides easier transport and storage.

14. The workbench assembly of claim 8, wherein the sawhorse further comprises:
a) a handle coupled to the track.

15. A workbench assembly, comprising:
a) a sawhorse having:
i. a track, and
ii. a pair of support legs extending downwardly from the track;
b) a mounting bracket configured to releaseably couple to the track of the sawhorse;
c) a planar member having a primary plane, being coupled to the mounting bracket and configured to provide a tabletop when the mounting bracket is coupled to the track, wherein the planar member is at least twice the width of the track and the primary plane tapers at a tapered end; and
d) a power outlet coupled to the planar member.

16. The workbench assembly of claim 15, further comprising:
a) a telescoping extension track configured to telescope into and out of the track, whereby the telescoping extension track provides an additional length of longitudinal support when extended.

17. The workbench assembly of claim 16, further comprising:
a) a carriage selectably coupleable to the telescoping extension track to place objects thereon.

18. The workbench assembly of claim 15, wherein the mounting bracket comprises:
a) a first flange configured to wrap around a first lip of the track;
b) a second flange configured to releaseably wrap around a second lip of the track; and
c) a mounting bracket body that couples the first flange and the second flange into a unit.

19. The workbench assembly of claim 15, wherein the pair of supporting legs swivel inwardly toward the track thereby providing a mechanism to collapse the pair of supporting legs for easier transport and storage.

20. The workbench assembly of claim 1, wherein the pair of supporting legs is detachable and thereby provides easier transport and storage.
